(19) United States
(12) Patent Application Publication
(10) Pub. No.: US 2009/0169967 A1
(43) Pub. Date: Jul. 2, 2009

(54) Fuel cartridge of fuel cell system

(75) Inventors: Cheng Wang, Hsinchu (TW); Jin-Shu Huang, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/230,144

(22) Filed: Aug. 25, 2008

(30) Foreign Application Priority Data
Dec. 28, 2007 (TW) 096150840

(51) Int. Cl. H01M 2/00

(52) U.S. Cl. 429/34

(57) ABSTRACT

A fuel cell system including a fuel cell stack and a fuel cartridge is provided. The fuel cartridge has a shell body and an air bag. The shell body forms a space for storing fuel. The shell body has a fuel outlet and an air inlet. The fuel outlet is connected to the fuel cell stack through a pipe. The air bag is assembled in the shell body with an opening thereof connected to and being in communication with the air inlet.

### BACKGROUND OF THE INVENTION

(1) Field of the Invention

This invention relates to a fuel cell system, and more particularly relates to a fuel cartridge of the fuel cell system.

(2) Description of the Prior Art

The exploitation and application of energy are indispensable for human lives, but the damage to environment grows day by day. Due to the advantages of high efficiency, low noise and no pollution, the development of fuel cell accords with the environmental protection trend. In present, there are various types of fuel cells, in which proton exchange membrane fuel cell (PEMFC) and direct methanol fuel cell (DMFC) are most popular.

Here takes DMFC for example. DMFC mainly includes a proton exchange film, a cathode and an anode. In the anode, the fuel (usually methanol) reacts with the accelerant to generate hydrogen ions and electrons. The electrons move to the cathode along an external circuit to generate current. The hydrogen ions move to the anode through the proton exchange film and then react with the electrons and oxygen to generate water. Hence, the fuel cell needs a steadily supplied fuel for generating stable power.

FIG. 1 is a schematic view of a typical fuel cell system 100. The fuel cell system 100 includes a fuel cartridge 160, a pump 140 and a fuel cell stack 120. The fuel cartridge 160 is used to load liquid fuel, such as methanol and ethanol, etc. The pump 140 is used to pump the fuel from the fuel cartridge 160 to the fuel cell stack 120 to generate power. The fuel in the fuel cartridge 160 is decreased attending with the operation of the fuel cell stack 120.

The fuel cartridge 160 in FIG. 1 has a shell body 162 and a fuel bag 164. The shell body 162 has an air inlet 162a and a fuel outlet 162b. The fuel is stored in the fuel bag 164. As the pump 140 pumps the liquid fuel, the air enters the shell body 162 of the fuel cartridge 160 through the air inlet 162a automatically, which balances the pressure inside and outside of the shell body 162, so that the liquid fuel may be drawn out from the fuel bag 164 smoothly. It is noted that, although storing the liquid fuel in the fuel bag 164 may avoid the danger of fuel leakage, however, when the liquid fuel is used up, the user has to change the whole fuel cartridge 160 instead of refilling liquid fuel to the fuel cartridge 160.

FIG. 2A is a schematic view of another typical fuel cell system 200. Unlike the fuel cell system 100 of FIG. 1, the shell body 262 of the fuel cartridge 260 in FIG. 2A has an opening 262a, which is covered with the impermeable membrane 264. The impermeable membrane 264 allows air molecule to penetrate, but holds back the liquid fuel molecule. Thus, as the pump 240 pumps the liquid fuel from the fuel outlet 262b, air enters the shell body 262 of the fuel cartridge 260 through the impermeable membrane 264 automatically to balance the pressure inside and outside of the shell body 262.

However, as shown in FIG. 2B, when the fuel cell 200 is inclined, part of the liquid fuel within the shell body may accumulate at the corner of the shell body 262 and is unable to be pumped to the fuel cell stack 220 by the pump 240. In addition, the impermeable membrane 264 is so fragile that the fuel in the shell body 262 may leak out of the shell body because of the breakage of the impermeable membrane 264. Moreover, when pumping the liquid fuel, the pump 240 has to overcome the resistance provided by the impermeable membrane 264 to let the air enter the shell body 262 through the impermeable membrane 264. Hence, the impermeable membrane 264 may increase power consumption for pump 240 operation.

Accordingly, a safe and easy-filled fuel cartridge is desirable for the fuel cell industry.

### SUMMARY OF THE INVENTION

It is an object of the present invention to provide a fuel cell system features a refillable fuel cartridge so as to save equipment cost and time cost.

It is another object of the present invention to provide a fuel cell system, which is capable of preventing fuel leakage.

It is another object of the present invention to reduce power consumption of the pump.

A fuel cell system includes a fuel cell stack and a fuel cartridge. The fuel cartridge has a shell body and an air bag. The shell body defines a space for storing fuel and has an air inlet and a fuel outlet. The fuel outlet is connected to the fuel cell stack through a pipe. The air bag is assembled in the shell body with an opening thereof connected to and being in communication with the air inlet.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiments illustrated in the drawings, in which:

FIG. 1 is a schematic view of a typical fuel cell system;

FIGS. 2A and 2B are schematic views of another typical fuel cell system;

FIGS. 3A to 3C are schematic views showing an embodiment of the fuel cell system according to the present invention;

FIG. 4 is a schematic view showing an embodiment of the fuel cell system according to the present invention;

FIGS. 5A and 5B are schematic views showing an embodiment of the fuel cartridge according to the present invention;

FIG. 6 is a schematic view showing another embodiment of the fuel cartridge according to the present invention; and

FIG. 7 is a schematic view showing an embodiment of the fuel cell system according to the present invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

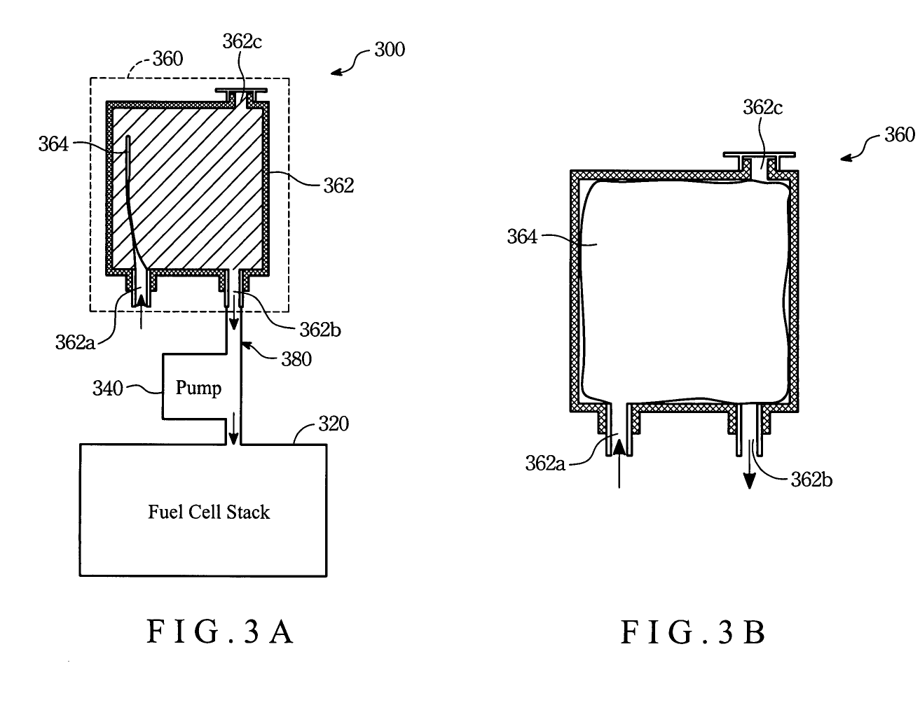

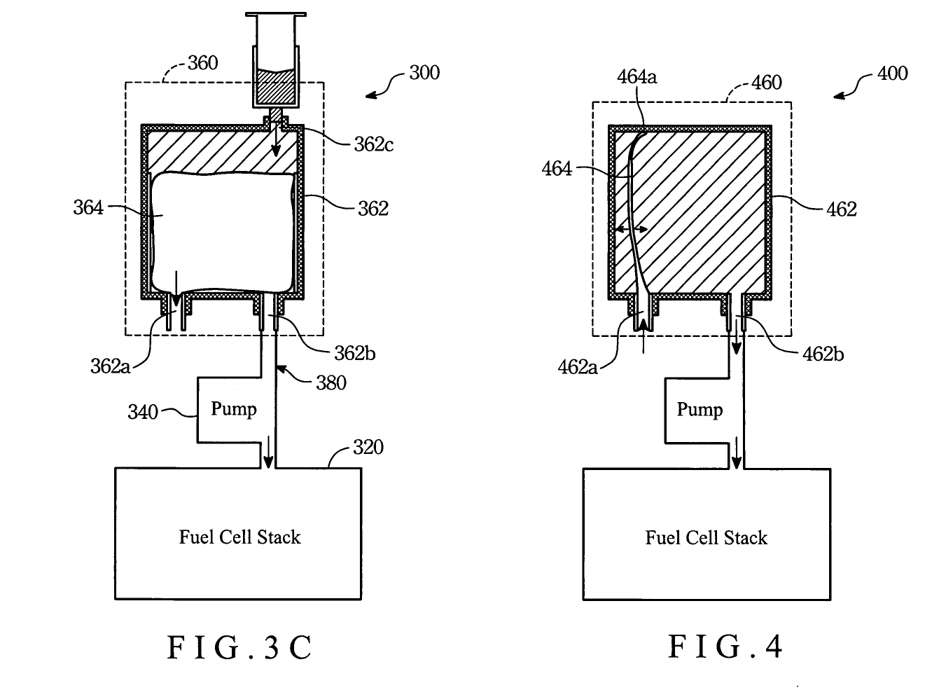

FIG. 3A is a schematic view showing an of the fuel cell system 300 according to the present invention. The fuel cell system 300 has a fuel cell stack 320, a pump 340, and a fuel cartridge 360. The fuel cartridge 360 is used for storing liquid fuel, such as methanol and ethanol, etc. In addition, the fuel cartridge 360 is connected to the fuel cell stack 320 through a pipe 380. The pump 340 is assembled on the pipe 380 for pumping the fuel from the fuel cartridge 360 to the fuel cell stack 320.

The fuel cartridge 360 has a shell body 362 and an air bag 364. The shell body 362 defines a space therein for storing fuel. The shell body 362 has a fuel outlet 362b, an air inlet 362a and a fuel inlet 362c. The fuel outlet 362b is connected to the pipe 380 for supplying fuel to the fuel cell stack 320. The air bag 364 is assembled in the shell body 362 with an opening thereof connected to and being in communication with the air inlet 362a. Thereby, the interior of the air bag 364 is completely isolated from the fuel storing space within the shell body 362. The fuel inlet 362c is used for refilling fuel into the shell body 362 when the fuel in the shell body 362 is exhausted. It is noted that as the pump 340 pumps the fuel from the fuel outlet 362b, environmental air enters the air bag 364 through the air inlet 362a to balance the pressure between inside and outside of the shell body 362.

In the beginning, as shown in FIG. 3A, the shell body 362 is full of liquid fuel and air within the air bag 364 is expelled completely. When the fuel in the shell body 362 is used, the fuel is reduced and the air bag 364 expands to balance the pressure between inside and outside of the shell body 362 until the air bag 364 blocks the fuel outlet 362b completely as shown in FIG. 3B to stop fuel supply and notifies the user that the fuel in the shell body 362 is exhausted. Referring to FIG. 3C, when the fuel in the shell body 362 is used up, users may refill liquid fuel through the fuel inlet 362c into the shell body 362 instead of replacing the fuel cartridge 360. When refilling liquid fuel into the shell body 362, air in the air bag 364 is expelled and the air bag 364 may return to the situation as shown in FIG. 3A.

Referring to FIG. 3A, as an embodiment, the air bag 364 may be made of flexible materials. Thereby, when the fuel in the shell body 362 is used up, the air bag 364 gives the flexibility to expel the air within the air bag 364 out and have liquid fuel absorbed from the fuel inlet 362c so as to achieve the object of refilling the fuel cartridge 360.

FIG. 4 is a schematic view showing an embodiment of the fuel cell system 400 according to the present invention. Unlike the embodiment shown in FIG. 3A, the air bag 464 shown in FIG. 4 has a fixed end 464a attached to a predetermined position on the inner surface of the shell body 462 to control the expanding direction of the air bag 464 to avoid the air bag 464 blocking the fuel outlet 462b over-early, and to ensure that the fuel outlet 462b is blocked after the air bag 464 completely expands. In this embodiment, the fixed end 464a is located at the tail of the air bag 464 and is fixed on the inner surface of the shell body 462 away from the air inlet 462a. The expanding direction of the air bag 464 (as the arrow shows) is substantially perpendicular to a virtual line between the air inlet 462a and the fixed end 464a. However, the present invention is not limited to the present embodiment. As the location of the fuel outlet 462b varied, users may adjust the location of the fixed end 464a on the air bag 464 or the location on the shell body 462 that the fixed end 464a being attached to so as to change the expanding direction of the air bag 464 to make sure that the air bag 464 may block the fuel outlet 462b. Furthermore, unlike the embodiment of FIG. 3A, the shell body 462 of the fuel cartridge 460 in the present embodiment omits the fuel inlet. Although the fuel cartridge 460 shown in FIG. 4 may not be refilled, the omission of the fuel inlet helps to reduce the possibility of fuel leakage.

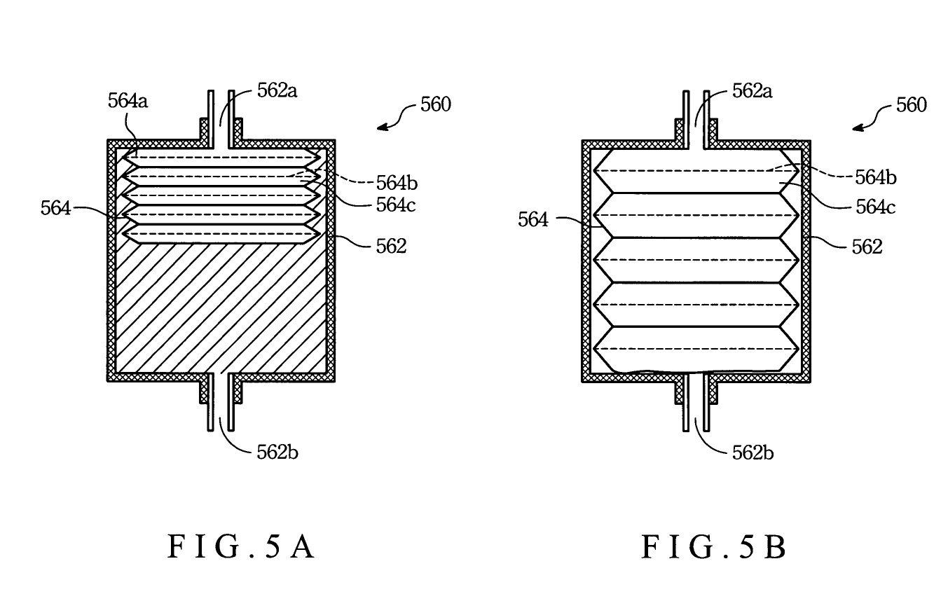

FIGS. 5A and 5B are schematic views showing an embodiment of the fuel cartridge 560 according to the present invention. Unlike the air bag 364 shown in FIG. 3A, the air bag 564 shown in FIGS. 5A and 5B has an extensible parts 564a. As air enters the air bag 564, the extensible parts 564a is stretched gradually to have the air bag 564 expand along the direction away from the air inlet 562a. In this embodiment, the extensible parts 564a include a plurality of annular lines 564b and a plurality of annular surfaces 564c between the annular lines 564b respectively. When the air bag 564 is shrunk, an angle between neighboring annular surfaces 564c is reduced and the annular surfaces 564c are overlapped. As air enters the air bag 564, the angle between neighboring annular surfaces 564c is extended. As an embodiment, the extensible parts 564a are symmetric about the air inlet 562a to ensure the air bag 564 expands toward the side of the shell body 562 away from the air inlet 562a to block the fuel outlet 562b as shown in FIGS. 5A and 5B. However, the present invention is not limited to the present embodiment. As the location of the fuel outlet 562b changed, the user may adjust the expanding direction of the air bag 564 by changing the shape of the extensible parts 564a.

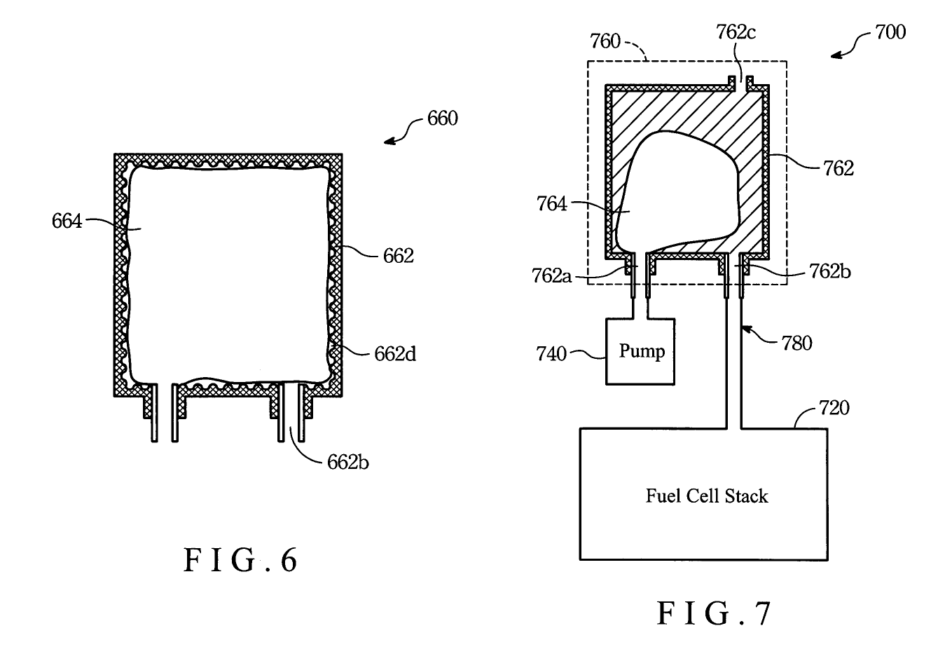

FIG. 6 is a schematic view showing another embodiment of the fuel cartridge 660 according to the present invention. Unlike the shell body 362 of the fuel cartridge 360 of FIG. 3A shown a flat inner surface, the inner surface of the shell body 662 of the fuel cartridge 660 in FIG. 6 shows a wavy surface, which forms a plurality of trenches 662d connected with each other. The trenches 662d are communicated with the fuel outlet 662b. When the air bag 664 is completely expanded, remaining fuel may flow to the fuel outlet 662b through the trenches 662d on the inner surface of the shell body 662. Therefore, the fuel cartridge 660 in the present embodiment is helpful to make sure the fuel in the shell body 662 is totally used.

FIG. 7 is a schematic view showing an embodiment of the fuel cell system 700 according to the present invention. The fuel cell system 700 includes a fuel cell stack 720, a pump 740 and a fuel cartridge 760. The fuel cartridge 760 is used for storing liquid fuel. The fuel cartridge 760 is connected the fuel cell stack 720 through the pipe 780. The pump 740 is connected to the air inlet 762a of the fuel cartridge 760 for pumping air into the air bag 764 of the shell body 762 to push the fuel from the fuel outlet 762b to the fuel cell stack 720.

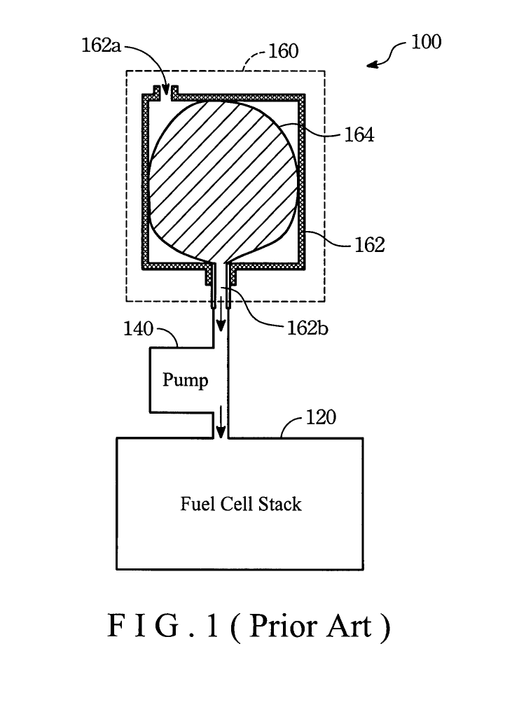

Referring to FIG. 1, liquid fuel of the traditional fuel cartridge 160 is loaded into the fuel bag 164, which is unable to refilled. In contrast, the fuel cartridge 360 in the embodiment of the present invention has the liquid fuel stored in the shell body 362. Thus, the user may refill liquid fuel through the fuel inlet 362c of the shell body 362.

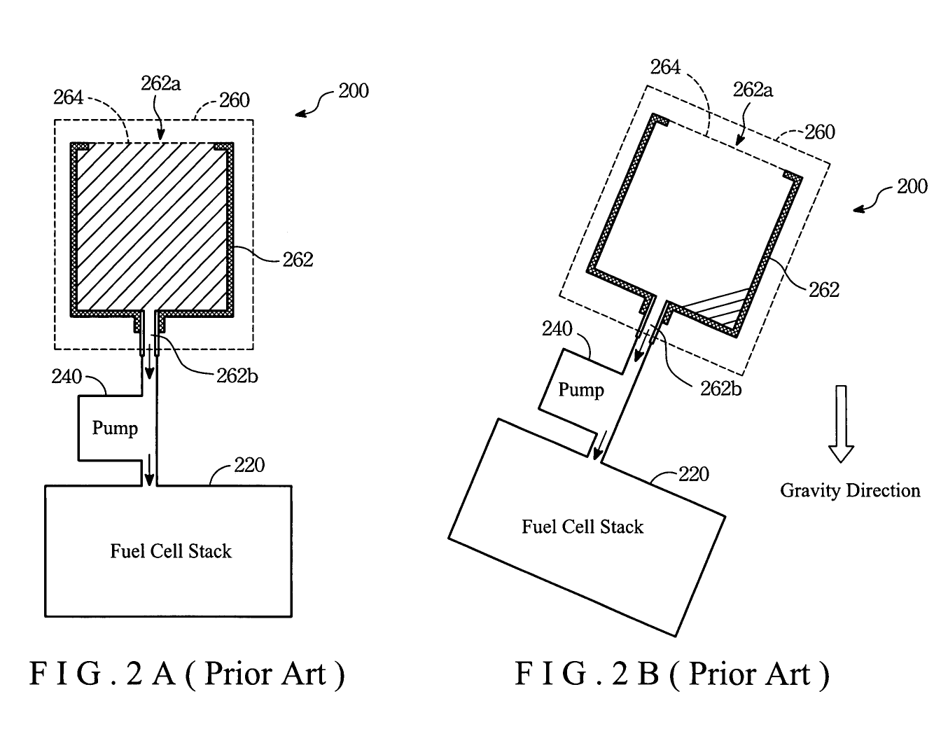

Referring to the FIG. 2B, part of liquid fuel within the traditional fuel cartridge 260 may be accumulated at the corner of the shell body 262 and is unable to be supplied to the fuel cell stack 220. In contrast, the fuel cartridge 360 in the embodiment of the present invention adopts the air bag 364 for pushing the liquid fuel in the shell body 362 to the fuel cell stack 320. The air bag 364 is capable of filling the whole space in the shell body 362 including the corner of the shell body 362. Thus, liquid fuel accumulated at the corner of the shell body 362 may be pumped to the fuel cell stack 320. Furthermore, since the embodiment of the present invention does not need to use the impermeable membrane 264 shown in FIG. 2A, it is helpful for reducing the possibility of fuel leakage as well as the power consumption of pump 340 pumping the liquid fuel.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system, comprising:
a fuel cell stack; and
a fuel cartridge, comprising:
a shell body, defining a space for storing fuel and having an air inlet and a fuel outlet, wherein the fuel outlet is connected to the fuel cell stack through a pipe; and
an air bag, assembled in the shell body with an opening thereof connected to and being in communication with the air inlet.

2. The fuel cell system of claim 1, further comprising a pump connected to the pipe to pump the fuel from the shell body to the fuel cell stack.

3. The fuel cell system of claim 1, further comprising a pump connected to the air inlet to pump air into the air bag.

4. The fuel cell system of claim 1, wherein the shell body has a fuel inlet for injecting the fuel into the shell body.

5. The fuel cell system of claim 1, wherein the air bag has a fixed end attached to an inner surface of the shell body, and the fixed end is away from the opening of the air bag.

6. The fuel cell system of claim 1, wherein the air bag has a plurality of extensible parts, and as air enters the air bag, the extensible parts are stretched to have the air bag expand toward a predetermined direction.

7. The fuel cell system of claim 6, wherein the extensible parts comprise a plurality of annular lines and a plurality of annular surfaces between the annular lines respectively.

8. The fuel cell system of claim 1, wherein the air bag is made of flexible materials.

9. The fuel cell system of claim 1, wherein as the air bag expands, the air bag blocks the fuel outlet.

10. The fuel cell system of claim 1, wherein the inner surface of the shell body shows a wavy surface.

11. A fuel cartridge of a fuel cell system, comprising:
a shell body, defining a space for storing fuel and having an air inlet and a fuel outlet for supplying fuel to a fuel cell stack; and
an air bag, assembled in the shell body with an opening thereof connected to and being in communication with the air inlet.

12. The fuel cartridge of claim 1 l,wherein the fuel outlet is connected to a pump.

13. The fuel cartridge of claim 1 l,wherein the air inlet is connected to a pump.

14. The fuel cartridge of claim 11,wherein the shell body has a fuel inlet for injecting the fuel into the shell body.

15. The fuel cartridge of claim 11, wherein the air bag has a fixed end attached to an inner surface of the shell body, and the fixed end is away from the opening of the air bag.

16. The fuel cartridge of claim 11, wherein the air bag has a plurality of extensible parts, and as air enters the air bag, the extensible parts are stretched to have the air bag expand toward a predetermined direction.

17. The fuel cartridge of claim 16, wherein the extensible parts comprise a plurality of annular lines and a plurality of annular surfaces between the annular lines respectively.

18. The fuel cartridge of claim 11, wherein the air bag is made of flexible materials.

19. The fuel cartridge of claim 11,wherein as the air bag expands, the air bag blocks the fuel outlet.

20. The fuel cartridge of claim 11, wherein the inner surface of the shell body shows a wavy surface.
